(19) United States
(12) Patent Application Publication
(10) Pub. No.: US 2021/0248568 A1
(43) Pub. Date: Aug. 12, 2021

(54) PRODUCT CARE LIFECYCLE MANAGEMENT

(71) Applicant: Blustream Corporation, Worcester, MA (US)

(72) Inventors: Robert Bean, Sandwich, MA (US); Michael Dominick Audi, Worcester, MA (US); James Michael Gordon, Jr., Worcester, MA (US); Kenneth N. Rapp, Sutton, MA (US); William Buote, Bellingham, MA (US)

(21) Appl. No.: 17/052,503

(22) PCT Filed: May 3, 2019
(86) PCT No.: PCT/US2019/030638

§ 371 Date: Nov. 2, 2020

Related U.S. Application Data
(60) Provisional application No. 62/666,156, filed on May 3, 2018.

(51) Int. Cl. G06Q 10/00; G06Q 30/02; G06N 20/00; H04L 29/08

(52) U.S. Cl. CPC G06Q 10/20; H04L 67/125; G06N 20/00; G06Q 30/0281

(57) ABSTRACT

A method includes receiving, by a server, data characterizing a measurement of a characteristic property of a first target by a sensor operatively coupled to the first target object. An object monitoring system includes the server and the sensor. The method further includes generating, by the server, a recommendation for a user of the first target object based on the received data and data characterizing a result associated with an implementation of a previous recommendation on the first target object. The generating includes application of recommendation rules associated with one or more of the first target object and a target object group that includes the first target object. The method further includes transmitting the generated recommendation.

### RELATED APPLICATION

This application claims priority under 35 U.S.C. § 119 (e) to U.S. Provisional Patent Application No. 62/666,156 filed on May 3, 2018, the entire contents of which is hereby expressly incorporated by reference herein.

### TECHNICAL FIELD

The subject matter described herein relates to monitoring objects.

### BACKGROUND

Sensors are an integral part of modern electronic devices such as cellphones, automobile circuitry, and the like. A sensor can detect physical properties such as motion, temperature, position, and the like, and generate a signal that represents the detected physical property. The generated signal can be processed and stored by a computing device. The computing device can control the operation of the sensor. For example, the computing device can control the operation of the sensor (e.g., change the operating parameters associated with the sensor).

SUMMARY

In an aspect, a method includes receiving, by a server, data characterizing a measurement of a characteristic property of a first target by a sensor operatively coupled to the first target object. An object monitoring system includes the server and the sensor. The method further includes generating, by the server, a recommendation for a user of the first target object based on the received data and data characterizing a result associated with an implementation of a previous recommendation on the first target object. The generating includes application of recommendation rules associated with one or more of the first target object and a target object group that includes the first target object. The method further includes transmitting the generated recommendation.

One or more of the following features can be included in any feasible combination. For example, the method can include generating, by an object machine learning algorithm executed by the server, a first set of object rules associated with the first target object based on one or more of information associated with the first target object provided by the user, previous measurement of the characteristic property by the sensor, data characterizing the result associated with an implementation of previous recommendations by the server and sensor measurements associated with a plurality of target objects of the target object group. The recommendation rules can include the first set of object rules.

The method can include generating, by a group machine learning algorithm executed by the server, a second set of object rules associated with the target object group based on one or more of the information associated with the first target object provided by the user, the previous measurement of the characteristic property by the sensor, the data characterizing the result associated with the implementation of previous recommendations by the server and the sensor measurements associated with the plurality of target objects of the target object group. The recommendation rules can include the second set of object rules. The method can include modifying one or more of the first set of object rules and the second set of object rules based on input rules provided by a product subject matter expert. The method can include determining, by a transmission machine learning algorithm executed by the server, one or more properties associated with the transmission of the generated recommendation based on input rules provided by a digital subject matter expert.

The method can include receiving data characterizing a second result associated with the implementation of the generated recommendation; receiving new data characterizing a measurement of the characteristic property of the first target object by the sensor; updating the first and the second set of object rules based on the received data characterizing the second result and the new data characterizing the measurement of the characteristic property; and generating, by the server, a new recommendation for the first target object based on application of the updated first and the updated second set of object rules on the received new data.

Generating the recommendation for the first target object can be further based on one or more of environmental data associated with the first target object, usage of the first target object, location of the first target object, an expertise level associated with the user, a type associated with the target object, a time associated with the generation of the recommendation, previous user or similar user actions or behavior, user interests, geographic data, proximal objects, and other similar objects. The object monitoring system can include an application on a computing device associated with the user of the first target object, and the receiving of the data by the server is via the application. The generated recommendation can be transmitted to the computing device. The method can include receiving a user query associated with the first target object by the application on the computing device associated with the user of the first target object; and generating, by a support engine supported by the server, an answer to the user query based on one or more of historical data associated with the first target object and an input from a second user of the object monitoring system. The method can include generating, by the support engine, a support engine query indicative of the user query; transmitting the support engine query to the second user; receiving a response from the second user; and generating the answer to the user query based on the received response from the second user. The generated recommendation can include information and/or instructions associated with care of the first target object. The method can include registering the target object with the server via the application on the computing device.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, and the like.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a flow chart of an exemplary method for providing a recommendation to a target object by an object monitoring system;

FIG. 2 illustrates an exemplary object monitoring system configured to monitor multiple target objects;

FIG. 3 illustrates an exemplary server associated with the object monitoring system of FIG. 2;

FIG. 4 illustrates an exemplary recommendation engine associated with the server of FIG. 3;

FIG. 5 illustrates an exemplary rules engine associated with the server of FIG. 3;

FIG. 6 illustrates an exemplary data processing engine associated with the server of FIG. 3;

FIG. 7 illustrates an exemplary support engine associated with the server of FIG. 3;

FIG. 8 illustrates an exemplary graphical user interface (GUI) display space of an application associated with the object monitoring system of FIG. 2;

FIG. 9 illustrates an exemplary input GUI display space for a Product Subject Matter Expert;

FIG. 10 illustrates an exemplary GUI interface of a cigar end user;

FIG. 11 illustrates another exemplary GUI interface of a cigar end user; and

FIG. 12 illustrates an exemplary supplier GUI interface a cigar supplier.

Like reference symbols in the various drawings indicate like elements.

### DETAILED DESCRIPTION

Establishing and maintaining a channel of communication between a supplier of an object (or a product) and an end user of the object can be beneficial to both. For example, the supplier of an object (e.g., a valuable object of nostalgic value) may want to assure the end user that the object will be maintained and serviced after the end user has procured the object (e.g., throughout the life of the object). This can allow the end user to take good care of the object and maintain the value of the object. Communication between the supplier and the end user can also allow the supplier to collect information associated with the object, which can be used to improve object support provided by the supplier to the end user.

Currently, a robust and systematic communication between the end user and the supplier may not exist. As a result, both the end user and the supplier may not have detailed knowledge about each other. For example, products may be sold through lengthy distribution channels where the supplier may not know the identity of the end users. Product registrations system can be limited to few end users and a one-time data collection (e.g., demographic information of end users). Registration data can become obsolete over the lifetime of the product. Some implementations of the current subject matter enable improved exchange of information between the end user and the supplier during the life cycle of the object. The platform can provide recommendations (e.g., automated recommendations during the lifetime of the object) to the end user and can allow for retrieval of object information (e.g., results from implementation of the recommendation) for the supplier. The retrieved object information can allow the supplier to customize the recommendation for a given object or the end user of the object.

In some implementations, the supplier can be interested in knowing the characteristics (e.g., who, why, how, and the like) of the supplier's product usage by the end user, and about the success of end users in using the products. The supplier may want to be able to respond to questions or other issues that the end user may have (e.g., to insure greater success of end users with the product) based on usage characteristics. End users, on the other hand, may want information, help and support from suppliers to help them gain the most value from the product, take good care of the product, have brand influence on the future of the product, and the like. For example, an end user may want to quickly access guides, manuals, and online resources provided by the supplier to understand how to use the product, and may or may not want to feel connected to the supplier in any ongoing way. When additional products associated with the product need to be purchased, the end user may want to know about appropriate distribution channels for the purchase and evaluate the new purchase (e.g., based on price, availability, ease of purchase, brand, and the like). In some implementations, methods and systems herein can allow the end user to communicate with the supplier throughout the lifecycle of the product and request information regarding accessories associated with the product.

Some implementations of the current subject matter can provide automated recommendations during a valuable product's lifecycle by analyzing data about the valuable product's environment, activities, and external information (e.g., time, weather, location, object properties, and the like). Further examples of data can include the end user's experience, preferences, collection, and the like. For example, if an individual has a room of guitars, the recommendation can include a suggestion for buying a dehumidifier/humidifier. If an individual is a beginner guitar player, the recommendation may include a recommendation to purchase light strings rather than heavy strings which are suited for an experienced guitar player.

Some implementations of the current subject matter can improve the communication characteristics (e.g., communication of recommendations) to ensure effective actions based upon supplier recommendations and end user actions over time. Some implementations of the current subject matter can provide systems and methods that can create opportunities for both the end users and the supplier to form an individual relationship where the end user is connected to the supplier for support while using the product throughout the life cycle of the product. This can allow the supplier to customize the relationship with each individual end user which can help to ensure end user's success with the product. End users can benefit from such a relationship by gaining better results and enjoyment from the products they use, while suppliers can benefit by gaining higher success rates, ratings, repeat sales and ongoing revenue from the products.

Existing communication channels between end users and suppliers can be expensive and may only be available to suppliers with very large customer audiences. This may allow for limited exchange of information for a given product/brand. However, a given user can use multiple brands and the existing communication channels do not provide a holistic information exchange for multiple brands. Additionally, Customer Relationship Management (CRM) systems that are often used for information exchange between the end user and the supplier are focused on the sales cycle of the product rather than the lifecycle information of the product.

Effective communication between suppliers and end users can contribute to a successful experience with a valuable object. The cause and effect of recommendations regarding the lifecycle care of an object can begin as sub-optimal due to the lack of direct feedback from messaging between the suppliers and the end users. With each communication (e.g., user preferences, sensor data from sensors coupled to the object, and the like), there can be an opportunity to improve the communication. For example, specific personalized information can include information about the object (or the user of the object) and macro trend information can provide information about the group/class to which the object (or the user of the object) belongs.

The personalized information for a given user/object can be compiled based on communications from the end user/object (e.g., direct feedback from end users regarding recommended alerts, items purchased by the end user, sensor data and the like). Each communication can be tested, data regarding end user action can be captured, and parameters related to improvement of the communication between the supplier and the end user can be defined. A lack of response or inappropriate responses can also be used to evaluate and improve the communication. This process can be designed to be continually optimized. In addition, macro trend information can include information from multiple suppliers and end users of the specific valuable object category or type. The micro trend information can be used for continuous improvement of supplier-end-user communication.

In some implementations, the communication between the end user and the supplier can be optimized based on one or more of a personalized optimization layer and a group optimization layer. For example, the group optimization layer can generate desirable (e.g., optimal) parameters of communication based on macro trends information and the personalized optimization layer can generate desirable (e.g., optimal) parameters of communication based on personalized information for a given user.

In addition to communication related to lifecycle of the object, the end user can interact with the supplier in various capacities over his or her lifetime (Consumer Life Cycle or CLC). For example, the consumer's positive (or negative) experience with the object and its supplier or brand may influence additional purchases of that same brand. Alternatively, a negative experience with the product may prompt the end user to seek an alternate brand in the future. Therefore, lifetime value of an object can be improved if the supplier provides the end user with a great experience and the lifetime relationship between the consumer and suppliers can likewise improve.

Some implementations of the current subject matter can include a system where information associated with the product (e.g., macro trends information, personalized information, and the like) can be provided by a Product Subject Matter Expert (PSME) on the use of an object/product throughout its life (product lifecycle). In some implementations, the product (or object) lifecycle can include the state and stage of a product (e.g., events and milestones associated with the product, actions performed by the end user and/or by the platform on the product, and the like). The platform can include algorithms that can review each registered object as new data is available to determine if an event or a milestone has occurred. Depending on the stage and state of the object, actions (e.g., communication with the end user, a recommendation for the end user, a request for feedback, and the like). A database of end user responses and success in carrying out the recommended actions can be maintained. This database can be used to determine a metric (or a score), which can be used to determine desirable properties (or style) for communicating recommendations to the end user.

In some implementations, an application associated with a computing device of the end user can receive sensor data detected by sensors operatively coupled to the object. The sensor data can include, for example, temperature, humidity, motion, impact, location, sound level, vibration, and the like, associated with the object. This data can be combined with data sourced from outside references such as weather reports, event announcements, emergency incidents, and the like, and can be used by the system to independently assess the state of the object.

The end user can interact with the application to assess the state and the milestones of the object. As time progresses, the consumer lifecycle (CLC) can change and the end user becomes more familiar with the product/object. For example, in the beginning the end user may require more information on initial setup, first use, learning the proper way to care for and work with their new product. The end user may then evolve to intermediate, advanced, and possibly professional levels. Multiple product lifecycles (PLC) may be present in a single consumer life cycle (CLC).

A Digital Marketing Subject Matter Expert (DSME) can provide information associated with communication styles associated with communication between the end user and the supplier. The communication style can be determined based on the personality and style of the end user, available message delivery modes, and the like. DSME can provide a trigger that can initiate the recommendation generation process and/or the machine learning process (e.g., of the recommendation engine 302, rules engine 304, and the like). In some implementations, the system may not know which recommendation will be most effective for the target object of the given end user. Communication style parameters provided by the DSME can be used in a rotating manner as new behavior of the end user or predetermined conditions are encountered. The effectiveness of the recommendation to cause action can be measured and the results of these measurements can be used to select the mode and style of future recommendations from the available suite of recommendations. In some implementations, DSME can provide input via a DSME input portal. The DSME input portal can include a visual editing system for a DSME to enter rules associated with delivery of recommendation, nodes data notice and call to action messages.

In some implementations, the current subject matter can include a platform that supports these inputs in a generalized way that accommodates these experts (e.g., PSME, DSME, and the like) from a wide variety of products. The system can include an end user application that provides for sensing of the end user's product usage, the product environment, the type of product, and the like. The sensed data and other independent data can be processed, analyzed and mixed to create recommendations for the end user on how to better use the object. The system can communicate with the end user offering suggestions for the use and protection of the product and offers for appropriate consumables associated with the product as needed.

In some implementations, actions taken by the end user based on the recommendation can be received by the platform. These actions can be evaluated in the recommendation generation process (e.g., to cause the stage of the product/object, to determine that a milestone for the object has been reached, and the like). As new sensory data arrives, they can be assessed (e.g., by a data processing engine) based on the current stage of the target object to determine if any new end user messages are to be delivered.

In some implementations, a wide variety of products can be entered into the system without the need to prepare specific programming for them. The end users of the products may enjoy better performance, longer lifetime and enhanced security, protection and care of the specific products registered in the system. The suppliers of the products may enjoy better overall customer satisfaction and higher rates of repeat sales and increased sales of associated products. These benefits accrue because some implementations of the current subject matter can provide sensory data feedback from specific product instances as the products are used by end users. This data along with generally available public data provides the supplier of the product with superior knowledge of the use and application of the products.

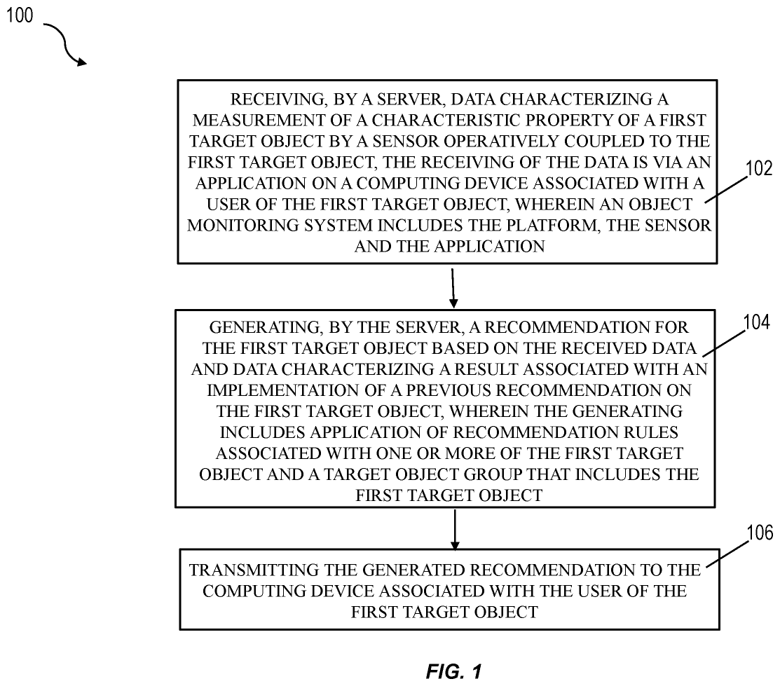

FIG. 1 is a flow chart of an exemplary method for providing a recommendation to a target object by an object monitoring system. At 102, data characterizing a measurement of a characteristic property of a first target object (e.g., which can be detected by a sensor operatively coupled to the first target object) is received. The data can be received, for example, by a platform (or a server) of the object monitoring system.

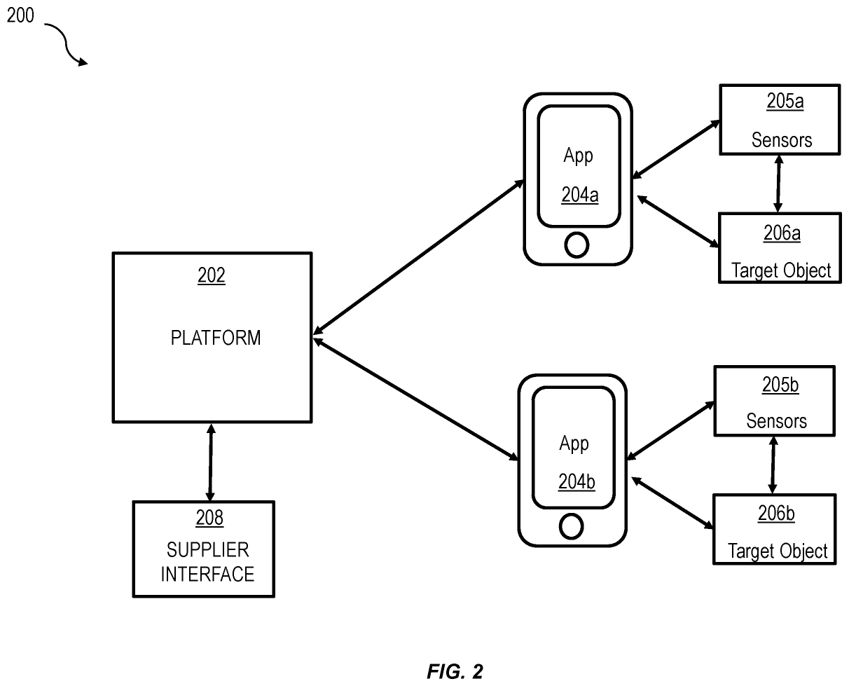

Various components of the object monitoring system can be distributed over a cloud, operating devices of users of multiple target objects, locations of the target objects (e.g., sensors coupled to target objects and the like). For example, FIG. 2 illustrates an exemplary object monitoring system 200 that includes a platform 202; applications 204a and 204b; sensors 205a and 205b; and a supplier interface 208. The object monitoring system 200 can monitor and provide recommendations to the target objects 206a and 206b. The sensor 205a (or 205b) can detect a characteristic property of the target object 206a (or 206b) and transmit the detected characteristic property to the application 204a (or 204b). The application 204a (or 204b) can be installed on a computing device (e.g., laptop, mobile device, and the like) of the user of the target object 206a (or 206b). The application can curate the received sensor data and/or transmit the sensor data to the platform 202. In some implementations, the application can be used by end users to place new orders (e.g., requesting registration for a new target object), request object information, and the like.

The platform 202 can receive the data from the applications 204a (or 204b) (e.g., data characterizing a measurement of the characteristic property of the target object) and/or sensor data directly from the sensor 205a (or 205b). The supplier interface 208 can allow the supplier to access information in the object monitoring system 200 (e.g., information about the product/object, end users, and the like).

Communication among platform 202; applications 204a and 204b; and sensors 205a and 205b can be achieved via one or more of WiFi, Cellular Radio, Bluetooth, low data rate infrastructure, direct wiring, and the like. In some implementations, one or more relay stations can allow for communication among the components of the object monitoring system 200. In some implementations, the various components of the object monitoring system 200 can include data storage devices (e.g., memory, RAM, and the like) that can curate received/generated information.

Referring again to FIG. 1, at 104, the platform 202 generates a recommendation for the target object 206a (or 206b) based on the received data. As described below, the generation of the recommendation can also be based on various data (e.g., result associated with the implementation of a previous recommendation on the target object 206a, sensor data from multiple target objects, expert data, and the like). Furthermore, the recommendation can be generated by application of various rules (e.g., predetermined rules, rules provided by experts, and the like) on the various data.

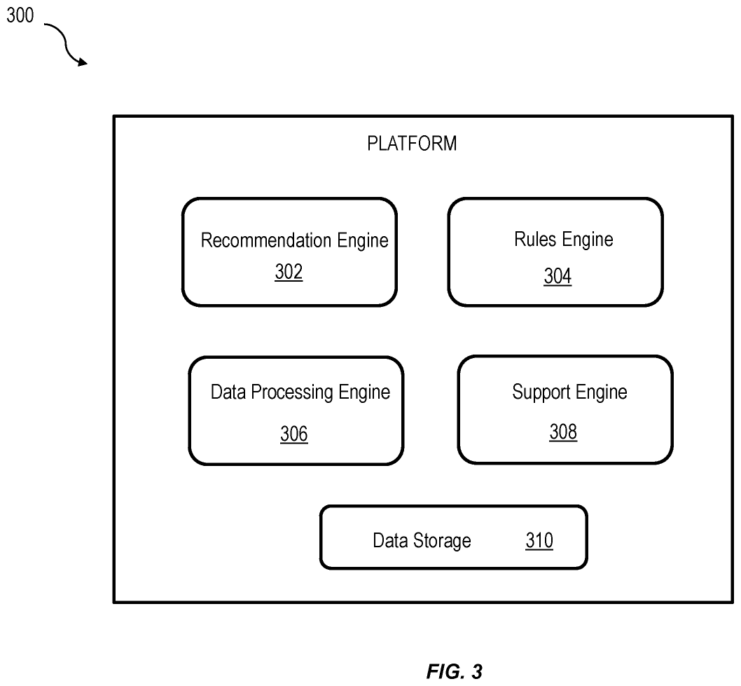

FIG. 3 illustrates an exemplary platform 300. The platform 300 can include a recommendation engine 302, rules engine 304, data processing engine 306, support engine 308 and data storage 310. The platform 300 can receive data from various sources (e.g., sensors operatively coupled to the objects, external database, experts, and the like). The recommendation engine 302 can generate recommendations based on, for example, received data, rules generated by the rules engine 304 (and/or rules from experts). The data processing engine can process the received data (or a portion thereof) and the support engine 308 can respond to queries from the end user.

The data storage 310 can store various information associated with the target objects. For example, data storage 310 can included the lifecycle information of the target object (e.g., stage of the object, milestone of the object, action level criteria, notifications associated with the object, and the like). The data storage 310 can also include information associated with the class or group associated with the target object. For example, if the target object is a guitar, the storage 310 can include information associated with various guitars registered with the platform 300. The group information can include, for example, summary notice content in target objects of the group, summary notice call to action in multiple target objects in the group, and the like.

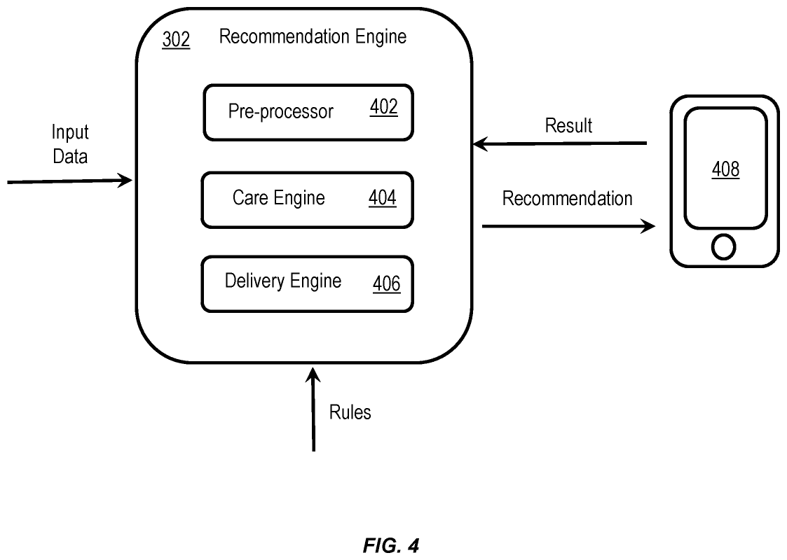

FIG. 4 illustrates an exemplary recommendation engine 302. The recommendation engine 302 can receive data from various sources (e.g., sensor data, rules from the rules engine, data from data storage 310, and the like) and can generate recommendation for the target object. In some implementations, the recommendation can instruct the end user to act to protect, preserve or better use the target object associated with the recommendation. The recommendation engine 302 can include a pre-processor engine 402, a care engine 404 and the delivery engine 406. The pre-processor engine 402 can process received data (e.g., sensor data, data from data storage 310, and the like). In some implementations, the processing of data can be done to prepare (or analyze) the data for execution by the care/delivery engines. For example, received data can be unstructured, or only a fraction of the data may be needed to produce an actionable insight by the care and delivery engines. The pre-processor engine 402 can select the desirable sub-set of data and/or prepare the data for usage by the care/delivery engines.

In some implementations, an algorithm or rule can analyze the received data and determine recommendation characteristics (e.g., whether the recommendation should be in a text form or a video form). This determination can be on historical user response to various recommendations (e.g., how often the user looked at the recommendation, how long the user spent engaging with the object monitoring system, how successful the resulting care actions were, etc.) to determine recommendation characteristics. In some implementations, recommendation characteristics can be transmitted to the delivery engine.

The care engine 404 can receive processed data from the pre-processor 402 and can generate recommendations. For example, the care engine 404 can apply rules (e.g., group rules, individual object rules, expert rules, and the like) received from the rules engine 304 and can apply those rules on the received data. Rules can be applied based on defined triggers. In some implementations, triggers can be time based, based on received data, an external event from a supplier's server, and the like. When a trigger fires, the care engine 404 can determine which rule or rules need to be executed. The execution of the rule may take place on the same server as the care engine or on a different server. The rule may or may not be provided all of the data with the trigger that is needed to execute the rule. If additional data is needed, the care engine 404 may try and get the data from a database, server, or other location. The care engine 404 can process the rule with the limited data, or may stop the execution of the rule.

For example, transmission from a sensor indicating that a given guitar of brand X has not moved within the last hour can triggers the rule engine to determine that a lack of movement data for the guitar corresponds to Rule 1. Rule 1 can state that if the guitar has not moved for over 30 days, the user should loosen the guitar strings. Rule 1 may only have the data that it has not moved in the last 24 hours, so it queries the data from a database to find out if the guitar has moved in the last 30 days or not. If the answer is negative, a recommendation can be sent to the owner.

In some implementations, the care engine 404 can determine an evaluation parameter for one or more registered target objects by applying the received rules on the received data. Based on the evaluation score, the recommendation engine can make a determination if a recommendation needs to be made. In some implementation, the recommendation can be determined (e.g., selected from a predetermined list of recommendations) based on the evaluation score. The recommendation can indicate, for example, if an operating state (or operating parameter) of the target object should be changed by the end user.

Referring again to FIG. 1, at 106, the generated recommendation (e.g., generated by the care engine 404) can be transmitted to the computing device (e.g., application 204a in the user computing device) associated with the first target object (e.g., 206). The delivery engine 406 can generate parameters associated with the communication (“communication parameters”) of the recommendations generated by the care engine 402. For example, the delivery engine 406 can determine the schedule for providing the recommendation to the user. In some implementations, the communication parameters can be based rules provide by a Digital Marketing Subject Matter Expert (DSME). In some implementations, the delivery engine 406 can determine additional information associated with the recommendation. For example, the delivery engine 406 can determine a schedule associated with the implementation of the recommendation (e.g., when the recommendation needs to be implemented, and the like).

In some implemenations, the delivery engine 406 can include a transmission machine learning algorithm. The transmission machine learning algorithm can generate the communication parameters based on information associated with the target object (e.g., personalized information for a given target object or the user of the target object), sensor data from the target object, input from DSME, and the like. In some implementations, the DSME can review and edit the communication parameters.

In some implementations, the recommendation engine 302 can perform multiple iterations (e.g., based on new data, new rules, trigger inputs from the end user, trigger inputs based on predetermined condition, trigger inputs from experts and the like). In some implementations, an input from the PSME can trigger the recommendation engine 302 (e.g., to generate recommendation). The input from the PSME can include state/milestone of the target object, conditions/limiting values associated with the various states of the target object, and the like. The recommendation engine 302 can include one or more of a genetic algorithm, Bayesian network, rete algorithm, inference engine, predictive model, business rule, machine learning model, neural network, classification system (e.g., random forest), regression system (e.g., least squares), and the like. In some implementations, the PSME can instruct the recommendation engine 302 to perform a machine learning process (e.g., based on data in data storage 310).

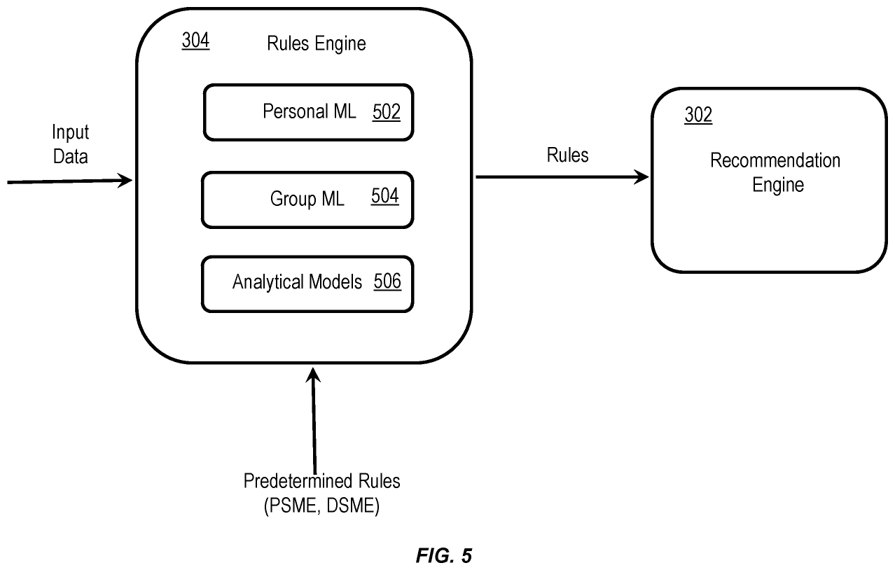

FIG. 5 illustrates an exemplary rules engine 304. The rules engine 304 can include a personal machine learning algorithm 502, a group machine learning algorithm 504 and analytical models 506. The personal machine learning algorithm 502 can generate a first set of object rules based on information associated with a given target object (e.g., personalized information for a given target object or the user of the target object) and/or macro trend information. The target object information can include one or more of data provided the by user of the target object, sensor data from the target object, data associated with a result from the implementation of a previous recommendation (e.g., from the platform 300 to the target object).

The group machine learning algorithm 504 can generate a second set of object rules based on information associated with a group (e.g., predefined group) associated with the target object. For example, the information can include macro trend information associated with the group of target objects. The target object information can include sensor measurements associated with a plurality of target objects in the group, group data from the data storage 310. In some implementations, the information can include personalized information.

In some implementations, generating the first (or second) set of rules can include using predetermined analytical models and varying the properties of the analytical models (e.g., predetermined constants in the analytical model) based on the above-mentioned personalized information (or macro trend information). In some implementations, the analytical models can include previously implemented rules. Based on new information (e.g., newly detected sensor data, new personalized information, new macro trend information, and the like), the previously implemented rules can be modified to generate new rules. In some implementations, the previously implemented first/second set of rules can be modified based on input rules provided by a PSME.

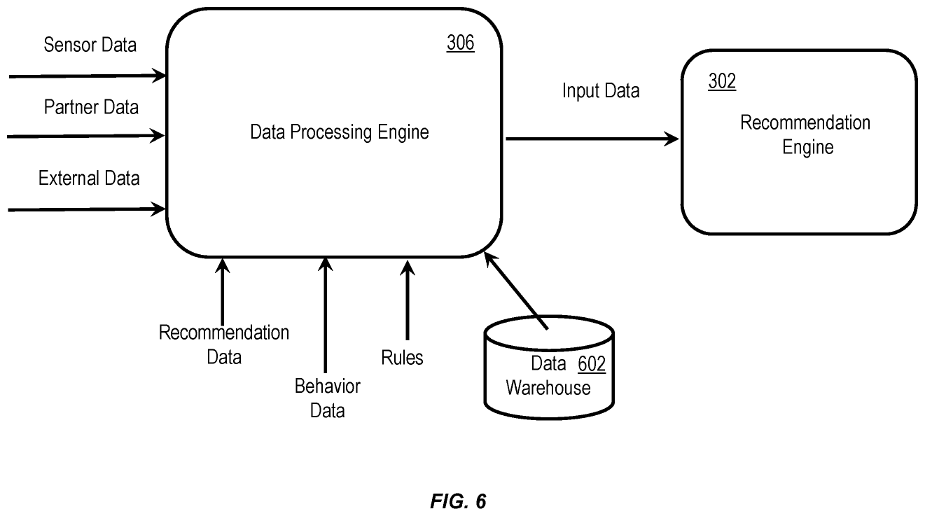

FIG. 6 illustrates an exemplary data processing engine 306. The data processing engine 306 can receive one or more of sensor data, recommendation data (e.g., data characterizing result of implementation of a recommendation), external data (e.g., geographic/weather data associated with a target object), partner data (e.g., data from a partner organization), behavior data (e.g., data associated with the past behavior of the object and/or user of the object), rules (e.g., rules from rules engine 306, and the like). The data processing engine 304 can process the received data to a form that can be used by the recommendation engine 302. In some implementations, the data processing engine can additionally process data and/or transform the data into a form that can be used by other users and services (e.g., supplier servers, data visualization software, data analytics, market research companies, software services such as customer support systems, marketing automation systems, customer relationship management systems, ecommerce systems, content management systems, inventory management, etc.). In some implementations, the data processing engine 306 can receive data from a data warehouse 602 that can store curated data associated with the object monitoring system.

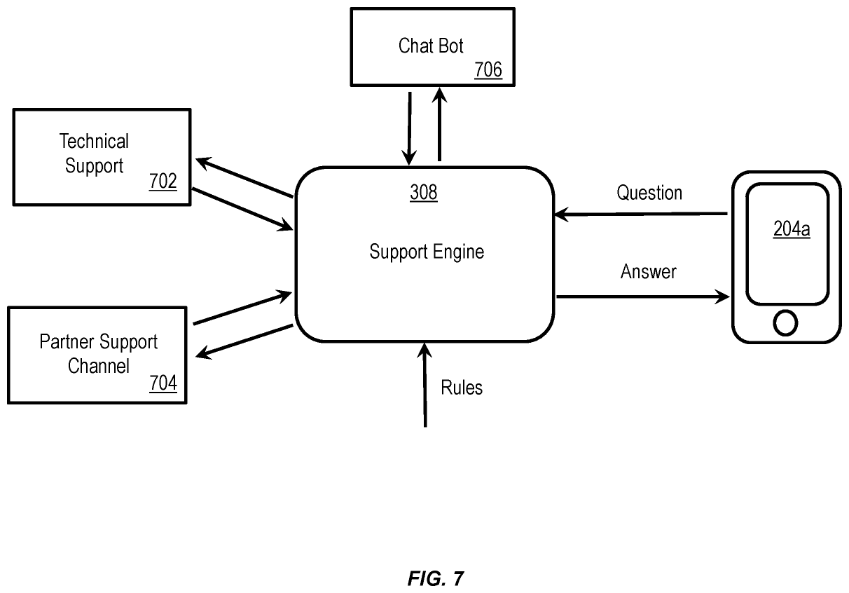

FIG. 7 illustrates an exemplary support engine 308. The support engine 308 can receive question/queries from a user of the application 204a (or 204b) executed in an operating device of the user of the object. For example, the user can ask questions related to the upkeep of the object (e.g., desirable temperature/humidity passociated with the object, precautionary steps that need to be taken in view of an impending set of external conditions, and the like). The support engine 308 can communicate with technical support 702, partner support channel 704, and a chat bot 706 in order to generate a reply to the user question. In some implementations, the support engine can peruse through a predetermined list of question in a database and identify a match for the received question, and generate an answer based on the predetermined list of answers in the database. In some implementations, the support engine 308 can transmit the received question to a technical support 702 or a chat bot 706 and request an answer. In some implementations, the support engine 308 can receive data from a partner support channel 704 and can retrieve the answer from the received data. In some implementations, the support engine 308 can also receive rules (e.g., from PSME, rules engine 304, and the like) and can apply the rules on existing data to determine the answer to the user question. After the answer has been determined the support engine 308 can transmit the answer to the user.

.

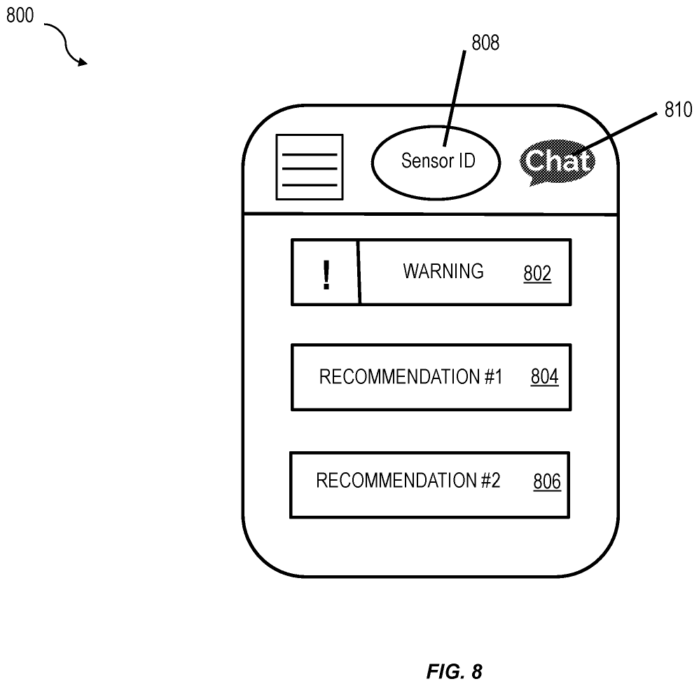

FIG. 8 illustrates an exemplary graphical user interface (GUI) display space 800 associated with the application (e.g., application 204a, 204b, and the like) executed on a user computing device. The GUI display space 800 can include a warning graphical object 802 and recommendation graphical objects 804 and 806. The warning graphical object 802 can be displayed when the platform 300 transmits a warning signal to the application. For example, based on sensor data, the platform 300 can determine that the operating conditions of the object are undesirable, and can warn the user. In some implementations, the application can include a predetermined set of rules that can be executed by a processor associated with the application. Based on the predetermined set of rules, the application can determine whether the operating conditions (e.g., detected by sensors coupled to the object) are undesirable. Once undesirable operating parameter of the object has been determined, the warning graphical object 802 can be displayed.

The GUI display space 800 can include one or more recommendation graphical objects (e.g., graphical objects 804 and 806). The recommendation graphical objects can include recommendations provided to the application by the platform 300. In some implementations, the recommendation graphical objects can include a schedule for implementations of the recommendation (e.g., several time markers indicative of degree of damage to the object if the recommendation is not implemented). The GUI display space 800 can allow the end user to implement the received recommendation.

The GUI display space 800 can include the identity 806 of the sensor (or the target object) that is under observation by the application. Sensor ID information can be helpful if the application is associated with multiple sensors (or target objects). The GUI display space 800 can include a query graphical object 810 that can allow the user to interact with the platform 300. For example, the user can transmit questions to the support engine 308 via the query graphical object 810. In some implementations, the end user (or an object associated with the end user) can be registered with the object monitoring system via the GUI display space 800. In some implementations, sensors (e.g., operatively coupled to target objects) can be registered with the object monitoring system via the GUI display space 800.

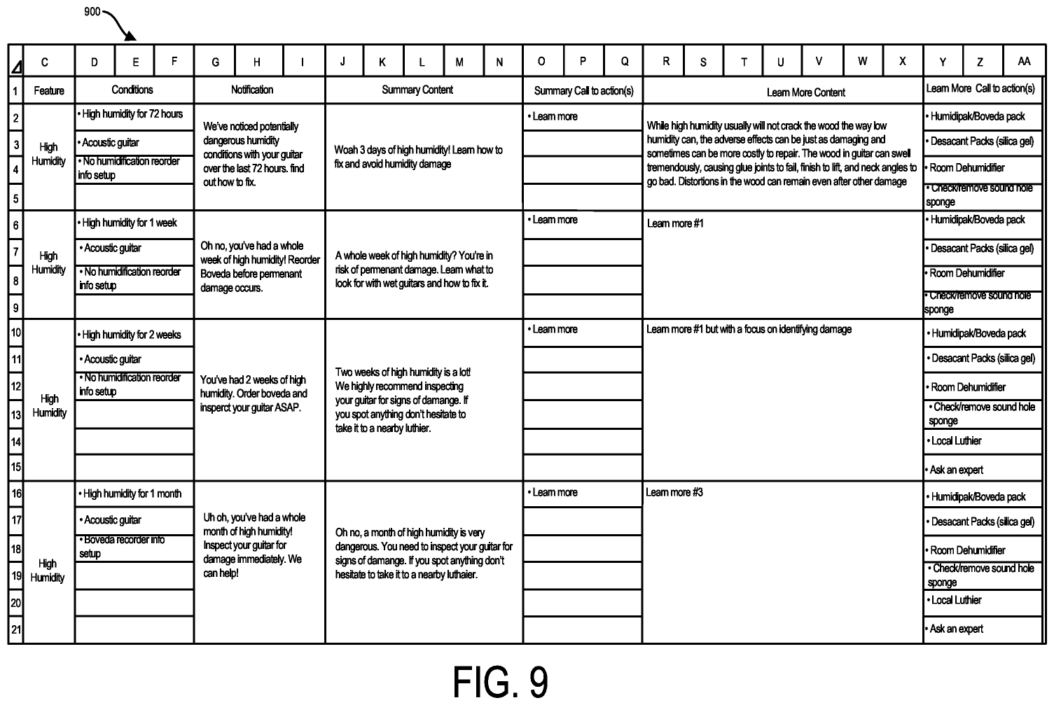

FIG. 9 illustrates an exemplary PSME input display space 900 via which the PSME can provide an input. The PSME can provide various information (e.g., data, rules, evaluation criteria for determining the recommendations and/or the rules, and the like) via the PSME input display space 900.

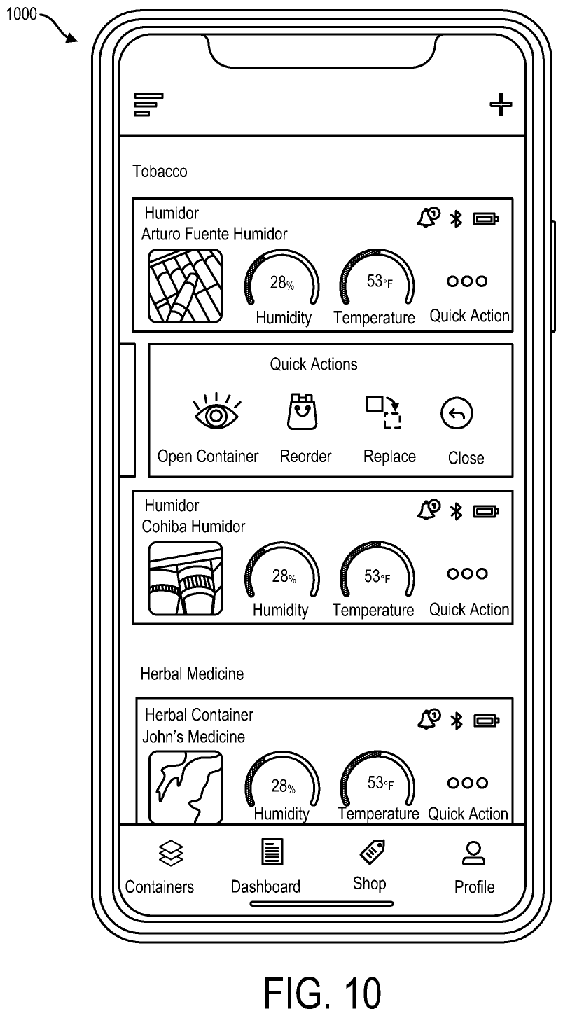

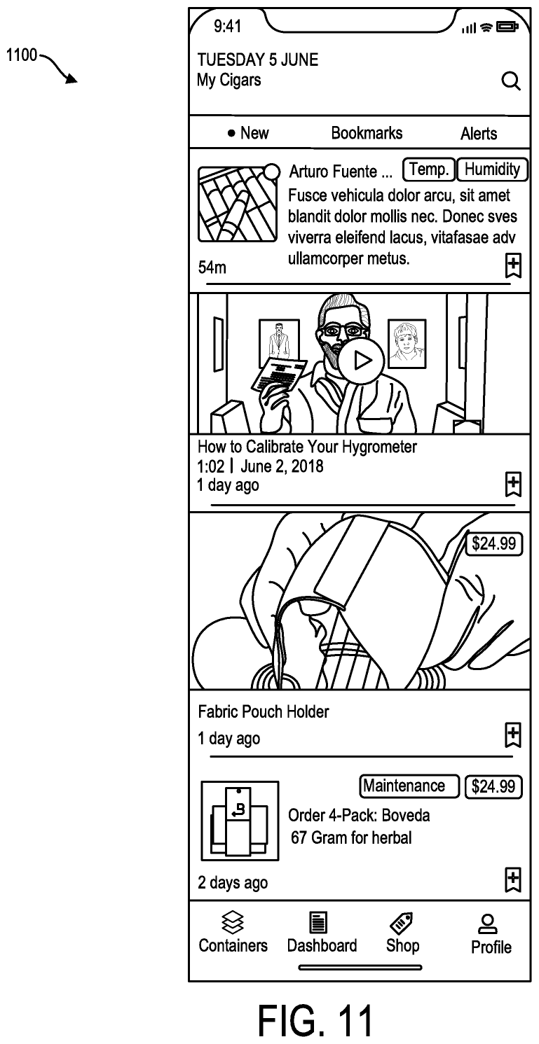

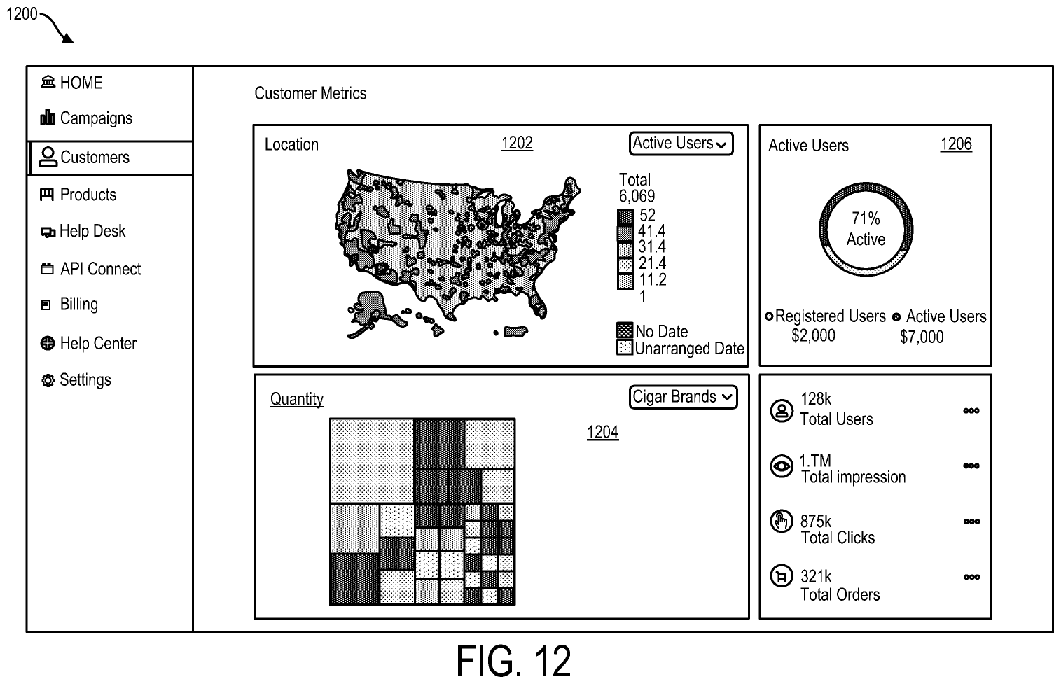

FIG. 10 illustrates an exemplary GUI interface 1000 of a cigar end user that includes recommendations from the object monitoring system about the container of the cigar. FIG. 11 illustrates an exemplary GUI interface 1100 of a cigar end user that includes recommendations on calibration of hygrometer for cigars. FIG. 12 illustrates an exemplary supplier GUI interface 1200 of a cigar supplier. FIG. 12 includes a map of the cigar users 1202, quantity of cigar usage based on brand of the cigar 1204, active user percentage 1206.

### Example Implementations

Musical Instrument

A musical instrument (e.g., a guitar) can receive maintenance and support through its life (“lifecycle care”) which can result in an improved customer experience. In this example, the lifecycle of the instrument is outlined that accounts for the timeline of activity of the device. Recommendations can be based on the lifecycle of the instrument.

Timeline of Instrument:

(A) Birth: As an instrument leaves the manufacturing unit, it can be shipped to its customer or retail store. It should be packaged properly to prevent damage from environmental conditions and impacts.

(B) Initial Set-up: Once removed from its case or shipping container, the instrument can be prepared for its first use. Environmental conditions can have an effect on the instrument. For example, the wood used in the instrument can determine the expansion or contraction (or regions thereof) of the instrument. This can change the playability, sound quality, and ability to maintain tuning of the instrument. Specific items such as setting the action, stringing the instrument, adjusting the truss rod, oiling the fret board, and the like, can all be important to the customer's experience with the instrument.

(C) Storage and Traveling: How the instrument is stored can dramatically change the health and value of the instrument. For example, moist environments can cause bowing of guitars while dry environments can cause cracking. The environmental impacts can affect the value of the instrument. Recommendations from the object monitoring system based on humidity, temperature, weather, and the like. can suggest using humidifiers, dehumidifiers, heating and cooling systems to the user. The object monitoring system can alert the user to adjust the storage conditions based on weather conditions of user's location. Such recommendations can have a dramatic effect on the value of the instrument.

(D) Playing and Performing: The amount of playing activities can be important when determining how best to care for the instrument. A low activity player may require the similar care and maintenance of their instrument as a high activity player, but less frequently. A large variety of parameters can be available to players that can be incorporated into the recommendations on how to get the most enjoyment and maintain the highest value of the instrument. The recommendations can include string type (e.g., steel coated string, nylon coated string, and the like), fret board oil, wood polish depending on wood type (e.g., mahogany, spruce, pine) of the guitar, action setting, saddle adjustments, truss rod adjustments, and the like.

(E) Maintenance: The combination of time and play activity defines the recommended maintenance profile of the instrument. Maintenance recommendations can include proper string selection, oiling fret boards, the right polish, setting specific action for the instrument, and the like. Recommendations can indicate that the instrument needs to be taken to a professional for a complete maintenance program. This complete maintenance program can be recommended on an annual basis and sooner if play activity is high. A complete review of the storage conditions and play activity can determine the specific maintenance required for the instrument.

Example Pet: Bearded Dragon

Bearded dragons can make a great pet reptile. They do not get too large, eat a wide variety of foods, are active during the day, and are gentle. These friendly animals can be captive-bred, have limited care requirements, are readily available, and inexpensive. A bearded dragon can be a great addition to one's family. Bearded dragons can recognize and respond to their owners' voices and touch and are usually even-tempered. They can be great pets for someone who wants a reptile who likes to be held and taken out of his cage. They are generally easy to handle. For example, the owner can support their wide, flat bodies from underneath and allow them to walk from hand to hand as they move. Dragons can even be handled by children as long as the children are supervised by adults. Anyone who handles a dragon must wash up afterward.

Bearded dragons are lizards that are native to Australia. They live in rocky and arid regions of the country and are adept climbers. In the wild, they can be found on branches, basking on rocks, and staying cool in bushes and other shaded areas. Bearded dragons have large triangular heads and flat bodies with pointed ridges along the sides. Their scales are spiny and appear dangerous but are soft, flexible, and not very sharp. They are omnivorous, eating both insects and plants. These reptiles grow to be 16 to 24 inches long.

In order to take good care of a bearded dragon, the owner may want to make sure it receives proper care. For example, the owner may want to have everything needed to take care of the bearded dragon before it is bought. Recommendations from the object monitoring system can provide the owner with the list of desirable bearded dragon care items.

The recommendation can include getting a large cage (e.g., a large aquarium or terrarium with a screened top) because the animal can fully grow to about 24 inches. The recommendations can include a combination light fixture that supports fluorescent and incandescent lights (e.g., UVB fluorescent bulb. daylight bulb or heat emitter, and the like). The recommendations can include substrate for the bottom of the tank, hiding area for the bearded dragon, rocks, branches, or logs for climbing and basking. The recommendations can include food bowl, smooth insect bowl, and a water dish. The recommendations can include any additional decorations, backgrounds, or artificial plants to make the habitat look more natural.

The recommendations can include lighting and heating equipment. For example, fluorescent bulbs are the most widely used bulbs on the market today. These bulbs are relatively inexpensive, energy-efficient, and provide the proper wavelengths of UV rays to accommodate bearded dragons. Not just any fluorescent bulb may suffice. For example, the owner may need to use fluorescent bulbs that are specifically designed and manufactured for reptiles. Regular household fluorescent tubes may not have the UV output needed to benefit a captive-raised reptile. Supplying adequate UV radiation during the day can help ensure that bearded dragons can make vitamin D in their skin, which can allow them to absorb both calcium and phosphorus from their food. This can be essential for proper bone formation, muscle contraction and many of the body's normal metabolic processes. Without adequate UV light, dragons will draw calcium out of their bones, which then become soft and fracture easily. They can also have muscle tremors from poor muscle contraction, their organs will fail and, ultimately, they can die. The temperature in their tanks needs to range from 100 degrees Fahrenheit on one end, where they can bask in the UV light, to 70 degrees Fahrenheit on the other end, where they can cool off if they choose. Having the appropriate temperature gradient in the tank is essential to their health. Reptiles' body temperature can adjust to that of their environments, and the function of their immune systems, digestion and metabolism can be temperature dependent.

The fluorescent bulbs usually need to be placed within twelve inches of the bearded dragon so that it receives sufficient radiation. The fluorescent bulbs can become weaker over time and may requiring frequent replacement. The general rule of thumb is to replace fluorescent tubes every 6 months. UV light cannot penetrate glass, so when overhead UVB light sources are used, the top of the enclosure must be a wire mesh that is not too fine. The recommendations can indicate that the UVB light source should be less than 18 inches from where the Bearded Dragon spends most of its time (e.g., 10-12 inches may be optimal).

The recommendation can include suggestions for food and diet of the bearded dragon. Bearded dragons are omnivorous, and can eat both insects and vegetables. Adult dragons will also eat pinky mice, baby lizards, and the like. They tend to do best on a varied diet based primarily of vegetables. Bearded dragons can eat vegetables prepared in a desirable manner. For example, greens may need to be chopped up. The smaller the reptile the more finely chopped the greens need to be. A good mix of vegetables for these lizards can include raw shredded carrots, collard greens, dandelion greens, mustard greens, kale, and frozen vegetables like carrots, peas, and beans.

Recommendation for food of the bearded dragon can include common insects available for reptiles (e.g., crickets, mealworms, super worms, wax worms, and the like). Bearded dragons may usually eat all types of insects and insects should be a part of diet every other day. The insects may be gut loaded before feeding them to the pet dragon. Gut loading can include feeding the insects a nutritious meal before giving them to the bearded dragon. This way, the insects can pass along the nutrients to the bearded dragons. There are many commercially available cricket and insect diets for gut loading.

The recommendations can include dietary supplements. For example, the bearded dragon may need a calcium and vitamin D3 supplement. If the bearded dragon is lacking D3 and calcium it can get metabolic bone disease which can be fatal. The supplement may come in a powder form which the owner can sprinkle on the vegetables or coat the insects. Insects can be coated by placing and shaking them in a bag or a cup. The owner can add the supplement to the adult dragons diet about once a week. Breeding females, babies, and juveniles may need supplements more often.

The recommendations can include suggestions on cages and supplies. For example, bearded dragon may need spacious housing. For example, the housing should be larger than 36″×12″×18″ for one dragon. Bigger housing can be better especially when there are multiple bearded dragons. Height of the housing may be important because bearded dragons like to climb and sit on top of logs and branches. An aquarium or a terrarium fit-ted with a screened top can make a nice home for your pet.

The bearded dragon may need food bowl, smooth insect bowl (for mealworms, and the like), and water dish. Bearded dragons may need a hide area like a cave or a log. There may be many natural-looking commercial shelters available. Sturdy branches, logs or rock formations may be needed to keep the bearded dragon happy because bearded dragons like to climb and bask at high perches. The owner may have to make sure that the climbing areas are secure and the bearded dragons will not fall and get hurt. The owner can add artificial plants and decorations to his home to create a more scenic habitat.

The recommendations can include suggestions on landscaping and furniture for the bearded dragon. Branches for climbing and basking under the secondary heat source should be secure. These branches should be of various sizes and not ooze pitch or have a sticky sap (e.g., oak can works very well). The branches should be as wide as the width of the Bearded Dragon. Boards covered with indoor/outdoor carpet also make good climbing posts. Flat-bottomed, smooth rocks are a good addition to the habitat, and can help wear down the toe-nails, which in captivity, must be clipped often. Reptiles like a place where they can hide. This could be an empty cardboard box, cardboard tube, or flower pot. The hiding place should provide a snug fit and should be high in the enclosure. If the bearded dragon does not use its hiding place, a different hiding place may be tried or the dragon can be move to a different location. Appropriate plants (e.g., non-toxic) in the enclosure can provide humidity, shade, and a sense of security. They also add an aesthetic quality to the enclosure. Dracaena, Ficus benjamina, and hibiscus are good choices. It can be desirable that the plants have not been treated with pesticides and the potting soil does not contain vermiculite, pesticides, fertilizer, or wetting agents. Washing the plants with a water spray and watering it thoroughly several times to the point where water runs out of the bottom of the pot can help remove toxic chemicals, which may have been used. Keeping purchased plants in a different part of the house for a while before putting them in the enclosure can also be helpful.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A method comprising:
receiving, by a server, data characterizing a measurement of a characteristic property of a first target by a sensor operatively coupled to the first target object, wherein an object monitoring system includes the server and the sensor;
generating, by the server, a recommendation for a user of the first target object based on the received data and data characterizing a result associated with an implementation of a previous recommendation on the first target object,
wherein the generating includes application of recommendation rules associated with one or more of the first target object and a target object group that includes the first target object; and
transmitting the generated recommendation.

2. The method of claim 1, further comprising:
generating, by an object machine learning algorithm executed by the server, a first set of object rules associated with the first target object based on one or more of information associated with the first target object provided by the user, previous measurement of the characteristic property by the sensor, data characterizing the result associated with an implementation of previous recommendations by the server and sensor measurements associated with a plurality of target objects of the target object group, wherein the recommendation rules includes the first set of object rules.

3. The method of claim 2, further comprising:
generating, by a group machine learning algorithm executed by the server, a second set of object rules associated with the target object group based on one or more of the information associated with the first target object provided by the user, the previous measurement of the characteristic property by the sensor, the data characterizing the result associated with the implementation of previous recommendations by the server and the sensor measurements associated with the plurality of target objects of the target object group, wherein the recommendation rules includes the second set of object rules.

4. The method of claim 3, further comprising modifying one or more of the first set of object rules and the second set of object rules based on input rules provided by a product subject matter expert.

5. The method of claim 3, further comprising determining, by a transmission machine learning algorithm executed by the server, one or more properties associated with the transmission of the generated recommendation based on input rules provided by a digital subject matter expert.

6. The method of claim 3, further comprising:
receiving data characterizing a second result associated with the implementation of the generated recommendation;
receiving new data characterizing a measurement of the characteristic property of the first target object by the sensor;
updating the first and the second set of object rules based on the received data characterizing the second result and the new data characterizing the measurement of the characteristic property; and
generating, by the server, a new recommendation for the first target object based on application of the updated first and the updated second set of object rules on the received new data.

7. The method of claim 1, wherein generating the recommendation for the first target object is further based on one or more of environmental data associated with the first target object, usage of the first target object, location of the first target object, an expertise level associated with the user, a type associated with the target object, a time associated with the generation of the recommendation, previous user or similar user actions or behavior, user interests, geographic data, proximal objects, and other objects.

8. The method of claim 1, wherein the object monitoring system further includes an application on a computing device associated with the user of the first target object, and the receiving of the data by the server is via the application.

9. The method of claim 8, wherein the generated recommendation is transmitted to the computing device.

10. The method of claim 8, further comprising:
receiving a user query associated with the first target object by the application on the computing device associated with the user of the first target object; and
generating, by a support engine supported by the server, an answer to the user query based on one or more of historical data associated with the first target object and an input from a second user of the object monitoring system.

11. The method of claim 10, further comprising:
generating, by the support engine, a support engine query indicative of the user query;
transmitting the support engine query to the second user;
receiving a response from the second user; and
generating the answer to the user query based on the received response from the second user.

12. The method of claim 1, wherein the generated recommendation includes information and/or instructions associated with care of the first target object.

13. The method of claim 1, further comprising registering the target object with the server via the application on the computing device.

14. A system comprising:
at least one data processor;
memory storing instructions which, when executed by the at least one data processor, causes the at least one data processor to perform operations comprising:
receiving, by a server, data characterizing a measurement of a characteristic property of a first target by a sensor operatively coupled to the first target object, wherein an object monitoring system includes the server and the sensor;
generating, by the server, a recommendation for a user of the first target object based on the received data and data characterizing a result associated with an implementation of a previous recommendation on the first target object,
wherein the generating includes application of recommendation rules associated with one or more of the first target object and a target object group that includes the first target object and
transmitting the generated recommendation.

15. A computer program product comprising a non-transitory machine-readable medium storing instructions, which when executed by at least one programmable processor that comprises at least one physical core and a plurality of logical cores, cause the at least one programmable processor to perform operations comprising:
receiving, by a server, data characterizing a measurement of a characteristic property of a first target by a sensor operatively coupled to the first target object, wherein an object monitoring system includes the server and the sensor;
generating, by the server, a recommendation for a user of the first target object based on the received data and data characterizing a result associated with an implementation of a previous recommendation on the first target object,
wherein the generating includes application of recommendation rules associated with one or more of the first target object and a target object group that includes the first target object and
transmitting the generated recommendation.

16. The computer program product of claim 15, wherein the operations further comprising:
generating, by an object machine learning algorithm executed by the server, a first set of object rules associated with the first target object based on one or more of information associated with the first target object provided by the user, previous measurement of the characteristic property by the sensor, data characterizing the result associated with an implementation of previous recommendations by the server and sensor measurements associated with a plurality of target objects of the target object group, wherein the recommendation rules includes the first set of object rules.

17. The computer program product of claim 16, wherein the operations further comprising:
generating, by a group machine learning algorithm executed by the server, a second set of object rules associated with the target object group based on one or more of the information associated with the first target object provided by the user, the previous measurement of the characteristic property by the sensor, the data characterizing the result associated with the implementation of previous recommendations by the server and the sensor measurements associated with the plurality of target objects of the target object group, wherein the recommendation rules includes the second set of object rules.

18. The computer program product of claim 17, wherein the operations further comprising modifying one or more of the first set of object rules and the second set of object rules based on input rules provided by a product subject matter expert.

19. The computer program product of claim 17, wherein the operations further comprising determining, by a transmission machine learning algorithm executed by the server, one or more properties associated with the transmission of the generated recommendation based on input rules provided by a digital subject matter expert.

20. The computer program product of claim 17, wherein the operations further comprising:
receiving data characterizing a second result associated with the implementation of the generated recommendation;
receiving new data characterizing a measurement of the characteristic property of the first target object by the sensor;
updating the first and the second set of object rules based on the received data characterizing the second result and the new data characterizing the measurement of the characteristic property; and
generating, by the server, a new recommendation for the first target object based on application of the updated first and the updated second set of object rules on the received new data.
